(19) United States
(12) Patent Application Publication
(10) Pub. No.: US 2026/0126137 A1
(43) Pub. Date: May 7, 2026

(54) REFRIGERANT-TRANSPORTING HOSE AND MANUFACTURING METHOD THEREOF

(71) Applicant: THE YOKOHAMA RUBBER CO., LTD., Kanagawa (JP)

(72) Inventors: Kenta WAKABAYASHI, Kanagawa (JP); Miyuki NISHI, Kanagawa (JP)

(21) Appl. No.: 19/114,652

(22) PCT Filed: Jan. 24, 2023
(86) PCT No.: PCT/JP2023/002121

§ 371 Date: Mar. 24, 2025

(30) Foreign Application Priority Data
Sep. 29, 2022 (JP) 2022-156953
Sep. 29, 2022 (JP) 2022-157013
Oct. 13, 2022 (JP) 2022-164844
Oct. 28, 2022 (JP) 2022-173698
Oct. 28, 2022 (JP) 2022-173703
Oct. 28, 2022 (JP) 2022-173726
Dec. 12, 2022 (WO) PCT/JP2022/045679
Dec. 12, 2022 (WO) PCT/JP2022/045680

(51) Int. Cl. F16L 11/08; F25B 41/40

(52) U.S. Cl. CPC F16L 11/081; F25B 41/40

(57) ABSTRACT

Provided is a refrigerant-transporting hose having excellent flexibility, water vapor barrier properties, and heat resistance. A refrigerant-transporting hose (1) is characterized by including an outer layer (4), a reinforcing layer (3), and an inner layer (2), the outer layer including a resin composition containing 100 parts by mass of a polyisobutylene-backbone-bearing elastomer, from 10 to 150 parts by mass of a crosslinked resin, and from 2.5 to 25 parts by mass of a crosslinking agent for the polyisobutylene-backbone-bearing elastomer, and the resin composition constituting the outer layer having a water vapor permeability of 3.0 g·mm/(m²·24 h) or less.

### TECHNICAL FIELD

The present technology relates to a refrigerant-transporting hose and a manufacturing method thereof. More particularly, the present technology relates to a refrigerant-transporting hose to be used for an air conditioner of an automobile and a method for manufacturing the refrigerant-transporting hose.

### BACKGROUND ART

With the increasing demand for weight reduction of automobiles, efforts have been made to achieve the weight reduction by producing a hose that has been used for automobiles and is made of rubber with resin having high barrier properties in place of rubber to reduce thickness. In particular, a refrigerant-transporting hose for current automobile air conditioners is composed mainly of rubber. If the main material can be substituted with resin having high barrier properties, a weight reduction can be achieved.

Japan Unexamined Patent Publication No. H04-145284 A describes a hose for transporting a refrigerant such as Freon gas. An outer tube of the hose is made of thermoplastic elastomer composed of thermoplastic polyolefin resin and EPDM (ethylene propylene diene monomer) or butyl rubber.

An air conditioner of an automobile and the like are installed in a limited, narrow space in the automobile, and thus the refrigerant-transporting hose is required to have excellent flexibility and easy installation even in a narrow space. Permeation of water vapor from a hose outer side causes freezing of moisture inside an air conditioner, and thus a material forming an outer tube of the refrigerant-transporting hose is required to have excellent water vapor barrier properties. Furthermore, the refrigerant-transporting hose needs to be durable enough to withstand long-term use in the high-temperature and high-humidity environment inside an engine room.

However, because an outer tube of a resin hose described in Japan Unexamined Patent Publication No. H04-145284 A is made of thermoplastic elastomer containing thermoplastic polyolefin resin, heat resistance is not necessarily sufficient.

### SUMMARY

The present technology provides a refrigerant-transporting hose having excellent flexibility, water vapor barrier properties, and heat resistance.

The present technology (I) is a refrigerant-transporting hose including an outer layer, a reinforcing layer, and an inner layer, the outer layer including a resin composition containing 100 parts by mass of a polyisobutylene-backbone-bearing elastomer, from 10 to 150 parts by mass of a crosslinked resin, and from 2.5 to 25 parts by mass of a crosslinking agent for the polyisobutylene-backbone-bearing elastomer, and the resin composition constituting the outer layer having a water vapor permeability of 3.0 g·mm/(m²·24 h) or less.

The present technology (II) is a method for manufacturing the refrigerant-transporting hose of the present technology (I), the method including: preparing a composition for an outer layer by melt-kneading a polyisobutylene-backbone-bearing elastomer, a crosslinkable resin, and a crosslinking agent for the polyisobutylene-backbone-bearing elastomer; and adding a silanol condensation catalyst to the composition for an outer layer during extrusion molding of a hose and forming an outer layer by performing extrusion molding of a composition to which the silanol condensation catalyst is added.

The present technology includes the following embodiments.

[1] A refrigerant-transporting hose including an outer layer, a reinforcing layer, and an inner layer, the outer layer including a resin composition containing 100 parts by mass of a polyisobutylene-backbone-bearing elastomer, from 10 to 150 parts by mass of a crosslinked resin, and from 2.5 to 25 parts by mass of a crosslinking agent for the polyisobutylene-backbone-bearing elastomer, and the resin composition constituting the outer layer having a water vapor permeability of 3.0 g·mm/(m²·24 h) or less.

[2] The refrigerant-transporting hose according to [1], wherein the crosslinking agent for the polyisobutylene-backbone-bearing elastomer contains zinc oxide and an alkylphenol formaldehyde-based resin.

[3] The refrigerant-transporting hose according to [1] or [2], wherein a content of the zinc oxide in the resin composition constituting the outer layer is from 1 to 10 parts by mass based on 100 parts by mass of the polyisobutylene-backbone-bearing elastomer, and a content of the alkylphenol formaldehyde-based resin is from 1.5 to 15 parts by mass based on 100 parts by mass of the polyisobutylene-backbone-bearing elastomer.

[4] The refrigerant-transporting hose according to any one of [1] to [3], wherein the polyisobutylene-backbone-bearing elastomer in the resin composition constituting the outer layer is butyl rubber or modified butyl rubber, and the polyisobutylene-backbone-bearing elastomer is dynamically crosslinked.

[5] The refrigerant-transporting hose according to any one of [1] to [4], wherein the crosslinked resin in the resin composition constituting the outer layer is a crosslinked resin obtained by crosslinking a silane-modified resin, the silane-modified resin being obtained by modifying a thermoplastic resin with a silane compound.

[6] The refrigerant-transporting hose according to any one of [1] to [5], wherein the crosslinked resin in the resin composition constituting the outer layer is a crosslinked resin obtained by crosslinking a silane-modified polyolefin, the silane-modified polyolefin being obtained by modifying a polyolefin with a silane compound.

[7] The refrigerant-transporting hose according to any one of [1] to [6], wherein the crosslinked resin in the resin composition constituting the outer layer is a crosslinked resin obtained by crosslinking a silane-modified polypropylene, the silane-modified polypropylene being obtained by modifying a polypropylene with a silane compound.

[8] The refrigerant-transporting hose according to any one of [1] to [7], wherein the resin composition constituting the outer layer contains from 1 to 10 parts by mass of an anti-aging agent based on 100 parts by mass of the polyisobutylene-backbone-bearing elastomer.

[9] The refrigerant-transporting hose according to any one of [1] to [8], wherein the resin composition constituting the outer layer has TB₁₅₀, a strength at break at 150° C., of 1.0 MPa or more.

[10] The refrigerant-transporting hose according to any one of [1] to [9], wherein the resin composition constituting the outer layer includes a matrix and a domain, the matrix containing the crosslinked resin and the domain containing the polyisobutylene-backbone-bearing elastomer, the domain being dispersed in the matrix, and the matrix is crosslinked.

[11] The refrigerant-transporting hose according to any one of [1] to [10], wherein the resin composition constituting the outer layer includes a matrix and a domain, the matrix containing the crosslinked resin and the domain containing the polyisobutylene-backbone-bearing elastomer, the domain being dispersed in the matrix, and the domain is crosslinked.

[12] The refrigerant-transporting hose according to any one of [1] to [11], wherein the inner layer includes a thermoplastic resin composition containing 100 parts by mass of an elastomer and from 30 to 170 parts by mass of a thermoplastic resin, the thermoplastic resin composition has a sea-island structure in which the elastomer is present as a domain in a matrix including the thermoplastic resin, the thermoplastic resin contains from 50 to 100 parts by mass of a polyamide based on 100 parts by mass of the thermoplastic resin, the elastomer contains a polyisobutylene-backbone-bearing elastomer, and the thermoplastic resin composition further contains a phenylenediamine-based or quinoline-based anti-aging agent and a processing aid.

[13] A method for manufacturing the refrigerant-transporting hose according to any one of [1] to [12], the method including: preparing a composition for an outer layer by melt-kneading a polyisobutylene-backbone-bearing elastomer, a crosslinkable resin, and a crosslinking agent for the polyisobutylene-backbone-bearing elastomer; and adding a silanol condensation catalyst to the composition for an outer layer during extrusion molding of a hose and forming an outer layer by performing extrusion molding of a composition to which the silanol condensation catalyst is added.

[14] The method according to [13], further including, after the forming the outer layer, crosslinking the matrix in the resin composition constituting the outer layer by bringing the outer layer into contact with water or water vapor.

The refrigerant-transporting hose of the present technology has excellent flexibility, water vapor barrier properties, and heat resistance.

### BRIEF DESCRIPTION OF DRAWINGS

FIG. 1 is a cross-sectional view of a refrigerant-transporting hose.

FIG. 2 is a diagram illustrating an evaluation method of flexibility of a hose.

### DETAILED DESCRIPTION

An embodiment of the present technology (I) relates to a refrigerant-transporting hose.

The refrigerant-transporting hose is referred to as a hose for transporting a refrigerant for an air conditioner or the like. The refrigerant-transporting hose according to an embodiment of the present technology is particularly suitably used as a hose for transporting a refrigerant for an air conditioner of an automobile. Examples of the air conditioner refrigerant include hydrofluorocarbons (HFCs), hydrofluoroolefins (HFOs), hydrocarbons, carbon dioxide, ammonia, and water. Examples of the HFC include R410A, R32, R404A, R407C, R507A, and R134a. Examples of the HFO include R1234yf, R1234ze, 1233zd, R1123, R1224yd, and R1336mzz. Examples of the hydrocarbon include methane, ethane, propane, propylene, butane, isobutane, hexafluoropropane, and pentane.

The refrigerant-transporting hose according to an embodiment of the present technology includes an outer layer, a reinforcing layer, and an inner layer.

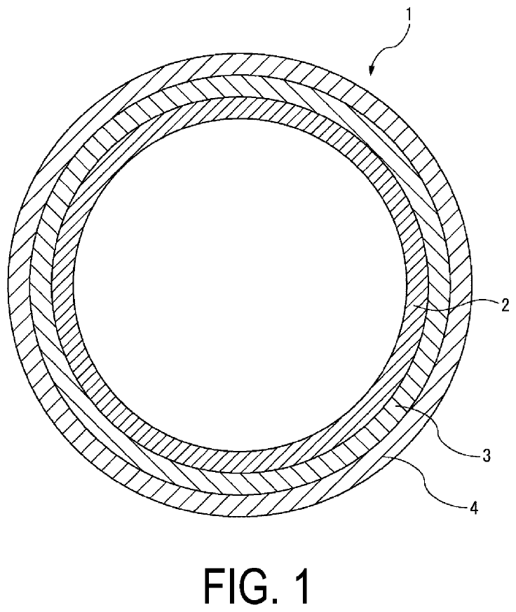

FIG. 1 is a cross-sectional view of a refrigerant-transporting hose according to an embodiment of the present technology. However, an embodiment of the present technology is not limited to what is illustrated in FIG. 1.

The refrigerant-transporting hose 1 includes an inner layer 2, a reinforcing layer 3 disposed on the outer side of the inner layer 2, and an outer layer 4 disposed on the outer side of the reinforcing layer 3.

The outer layer includes a resin composition containing 100 parts by mass of a polyisobutylene-backbone-bearing elastomer, from 10 to 150 parts by mass of a crosslinked resin, and from 2.5 to 25 parts by mass of a crosslinking agent for the polyisobutylene-backbone-bearing elastomer.

The polyisobutylene-backbone-bearing elastomer is not limited as long as the elastomer has a polyisobutylene backbone but is preferably butyl rubber (IIR), modified butyl rubber, or a styrene-isobutylene-styrene block copolymer, and is more preferably butyl rubber or modified butyl rubber.

The polyisobutylene backbone refers to a chemical structure formed by polymerization of a plurality of isobutylene, that is, a chemical structure represented by -[—CH₂—C(CH₃)₂—]ₙ- (however, n is an integer of 2 or more).

The butyl rubber refers to an isobutylene-isoprene copolymer obtained by copolymerizing isobutylene and a small amount of isoprene and is abbreviated as IIR.

The modified butyl rubber refers to butyl rubber, in which a double bond, a halogen, and the like are present in an isoprene backbone. As the modified butyl rubber, a halogenated butyl rubber is preferred, a brominated butyl rubber and a chlorinated butyl rubber are more preferred, and a brominated butyl rubber is even more preferred.

A styrene-isobutylene-styrene block copolymer is abbreviated as SIBS.

Because the resin composition contains the polyisobutylene-backbone-bearing elastomer, flexibility and water vapor barrier properties of the resin composition are improved.

The polyisobutylene-backbone-bearing elastomer is preferably dynamically crosslinked. The dynamic crosslinking improves durability.

The resin composition constituting the outer layer contains a crosslinked resin. The resin composition achieves excellent heat resistance because the resin composition contains a crosslinked resin.

The crosslinked resin refers to a resin that is crosslinked. The crosslinked resin is not limited but is preferably a crosslinked resin obtained by crosslinking a silane-modified resin. The silane-modified resin refers to a resin obtained by modifying a thermoplastic resin with a silane compound. The silane-modified resin is preferably a resin obtained by modifying a polyolefin-based thermoplastic resin with a silane compound and is more preferably a crosslinkable resin having a hydrolyzable silyl group (preferably an alkoxysilyl group) obtained by modifying a polyolefin-based thermoplastic resin with a silane compound.

That is, the crosslinked resin is preferably a crosslinked silane-modified resin obtained by modifying a thermoplastic resin with a silane compound, more preferably a crosslinked silane-modified polyolefin obtained by modifying a polyolefin with a silane compound, and even more preferably a crosslinked silane-modified polypropylene obtained by modifying a polypropylene with a silane compound.

The silane compound is not limited but is preferably a compound represented by Formula (1).

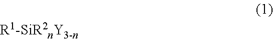

R¹ is an ethylenically unsaturated hydrocarbon group, R² is a hydrocarbon group, Y is a hydrolyzable organic group, and n is an integer of from 0 to 2.

R¹ is preferably an ethylenically unsaturated hydrocarbon group having from 2 to 10 carbon atoms, and examples thereof include a vinyl group, a propenyl group, a butenyl group, a cyclohexenyl group, and a γ-(meth)acryloyloxypropyl group.

R² is preferably a hydrocarbon group having from 1 to 10 carbon atoms, and examples thereof include a methyl group, an ethyl group, a propyl group, a decyl group, and a phenyl group.

Y is preferably a hydrolyzable organic group having from 1 to 10 carbon atoms, and examples thereof include a methoxy group, an ethoxy group, a formyloxy group, an acetoxy group, a propionyloxy group, an alkyl amino group, and an arylamino group.

Specific examples of the silane compound include vinyltrimethoxysilane, vinyltriethoxysilane, vinyltriacetoxysilane, and γ-methacryloyloxypropyltrimethoxysilane. Among these, vinyltrimethoxysilane is preferred.

The polyolefin-based thermoplastic resin constituting the silane-modified resin is not limited, and examples thereof include polyethylene, a copolymer of ethylene and α-olefin, polypropylene, and a copolymer of propylene and another α-olefin. Polypropylene and a copolymer of propylene and another α-olefin are preferred, and polypropylene is particularly preferred.

The hydrolyzable silyl group refers to a group generating a silanol group (≡Si—OH) by hydrolysis and is preferably a group represented by Formula (2).

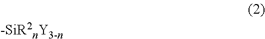

However, R² and Y are as described above.

A crosslinkable resin refers to a resin that can undergo a crosslinking reaction but that is not crosslinked yet. The type of crosslinking reaction is not limited and may be a crosslinking by a peroxide but is preferably a crosslinking by moisture (water crosslinking).

The method of modification with a silane compound is not limited and examples thereof include grafting and copolymerization. The grafting is a method for adding a silane compound to a resin by a grafting reaction and is more specifically a reaction of generating a carbon radical by cleaving a carbon-hydrogen bonding of polyolefin and adding a silane compound having an ethylenically unsaturated hydrocarbon group to the carbon radical. The modification can be preferably performed by melt-kneading a resin and a silane compound of Formula (1) in the presence of a radical generator, such as an organic peroxide. The copolymerization can be preferably performed by radical copolymerization of a monomer constituting a resin and a silane compound of Formula (1).

The silane-modified resin is preferably a silane-modified polypropylene. The silane-modified resin is commercially available, and a commercially available product can be used as the silane-modified resin used for an embodiment of the present technology. Examples of the commercially available product of the silane-modified resin include “Linklon” (trade name) available from Mitsubishi Chemical Corporation.

The content of the crosslinked resin is from 10 to 150 parts by mass, preferably from 10 to 100 parts by mass, and more preferably from 10 to 80 parts by mass based on 100 parts by mass of the polyisobutylene-backbone-bearing elastomer. When the content of the crosslinked resin is too small, extrudability becomes poor. When the content is too large, flexibility cannot be ensured.

The resin composition constituting the outer layer may contain a resin other than the crosslinked resin.

Examples of the resin other than the crosslinked resin include a polyolefin resin and a polyamide resin. Examples of the polyolefin resin include a polypropylene. Blending of the polypropylene in addition to the silane-modified resin forms a phase structure that tends to exhibit strength during heating because the viscosity of the resin component becomes stable. Furthermore, because the water vapor barrier properties of the polypropylene are good, the water vapor barrier properties of the entire composition become good.

The resin composition constituting the outer layer contains a crosslinking agent for the polyisobutylene-backbone-bearing elastomer. The “crosslinking agent for the polyisobutylene-backbone-bearing elastomer” is hereinafter also simply referred to as “crosslinking agent”. The resin composition achieves improved heat resistance after crosslinking (after dynamic crosslinking) because the resin composition contains the crosslinking agent.

The crosslinking agent preferably contains zinc oxide and an alkylphenol formaldehyde-based resin. Since the crosslinking agent contains zinc oxide and an alkylphenol formaldehyde-based resin, the resin composition after crosslinking (after dynamic crosslinking) can be imparted with heat resistance capable of withstanding even an environment at 150° C.

Zinc oxide refers to an oxide of zinc represented by the chemical formula ZnO. Zinc oxide is commercially available, and a commercially available product can be used for an embodiment of the present technology. Examples of the commercially available product include Zinc Oxide III, available from Seido Chemical Industry Co., Ltd.

The alkylphenol formaldehyde-based resin refers to a compound represented by Formula (3).

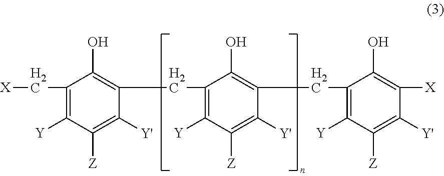

In Formula (3), X is a hydroxyl group or a halogen, Y and Y′ are hydrogen or alkyl groups, Z is an alkyl group or a halogen, and n is an integer of from 0 to 20. The halogen constituting X and Z is preferably fluorine, chlorine, bromine or iodine, and is more preferably bromine. The alkyl group constituting Y, Y′ and Z is preferably an alkyl group having from 1 to 8 carbon atoms.

The structural formula represented by Formula (3) is a straight chain, but the alkylphenol formaldehyde-based resin may be synthesized according to a known method and may have a branched portion.

The alkylphenol formaldehyde-based resin in which X is bromine is referred to as brominated alkylphenol formaldehyde-based resin.

The alkylphenol formaldehyde-based resin is commercially available, and a commercially available product can be used for an embodiment of the present technology. Examples of the commercially available product include alkylphenol-formaldehyde resin “Hitanol” (trade name) 2501Y, available from Hitachi Chemical Co., Ltd.

The content of the crosslinking agent is from 2.5 to 25 parts by mass, preferably from 2.5 to 20 parts by mass, and more preferably from 2.5 to 18 parts by mass based on 100 parts by mass of the polyisobutylene-backbone-bearing elastomer. When the content of the crosslinking agent is too small, the dynamic crosslinking of the elastomer becomes insufficient, and the strength during heating decreases. When the content is too large, the silane crosslinking of the resin is inhibited and the strength during heating decreases.

The content of the zinc oxide is from 1 to 10 parts by mass, preferably from 2 to 8 parts by mass, and more preferably from 3 to 8 parts by mass based on 100 parts by mass of the polyisobutylene-backbone-bearing elastomer. When the content of the zinc oxide is too small, the dynamic crosslinking of the elastomer becomes insufficient, and the strength during heating decreases. When the content is too large, the silane crosslinking of the resin is inhibited and the strength during heating decreases.

The content of the alkylphenol formaldehyde-based resin is from 1.5 to 15 parts by mass, preferably from 1.5 to 10 parts by mass, and more preferably from 2 to 10 parts by mass based on 100 parts by mass of the polyisobutylene-backbone-bearing elastomer. When the content of the alkylphenol formaldehyde-based resin is too small, the dynamic crosslinking of the elastomer becomes insufficient, and the strength during heating decreases. When the content is too large, the silane crosslinking of the resin is inhibited and the strength during heating decreases.

The resin composition constituting the outer layer preferably contains a silanol condensation catalyst. When the silanol condensation catalyst is contained, crosslinking of the silane-modified resin is promoted during formation of the crosslinked resin.

Examples of the silanol condensation catalyst include, but not limited to, a metal organic acid salt, a titanate, a borate, an organic amine, an ammonium salt, a phosphonium salt, an inorganic acid, an organic acid, and an inorganic acid ester.

Examples of the metal organic acid salt include, but not limited to, dibutyltin dilaurate, dioctyltin dilaurate, dibutyltin diacetate, dibutyltin dioctoate, tin (II) acetate, tin (II) octanoate, cobalt naphthenate, lead octylate, lead naphthenate, zinc octylate, zinc caprylate, iron 2-ethylhexanoate, iron octylate, and iron stearate.

Examples of the titanate include, but not limited to, tetrabutyl titanate, tetranonyl titanate, and bis(acetylacetonitrile) di-isopropyl titanate.

Examples of the organic amine include, but not limited to, ethylamine, dibutylamine, hexylamine, triethanolamine, dimethyl soya amine, tetramethylguanidine, and pyridine.

Examples of the ammonium salt include, but not limited to, ammonium carbonate and tetramethylammonium hydroxide.

Examples of the phosphonium salt include, but not limited to, tetramethylphosphonium hydroxide.

Examples of the inorganic acid include, but not limited to, sulfuric acid and hydrochloric acid.

Examples of the organic acid include, but not limited to, acetic acid, stearic acid, maleic acid, toluenesulfonic acid, and sulfonic acid such as alkylnaphthylsulfonic acid. Examples of the inorganic acid ester include, but not limited to, a phosphoric acid ester.

The silanol condensation catalyst is preferably a metal organic acid salt, sulfonic acid, or a phosphoric acid ester, and more preferably a metal carboxylate of tin such as dioctyltin dilaurate, alkylnaphthylsulfonic acid, or ethylhexyl phosphate. One type of silanol condensation catalyst may be used alone, or two or more types of the silanol condensation catalysts may be appropriately combined and used.

The content of the silanol condensation catalyst is not particularly limited but is preferably from 0.0001 to 0.5 parts by mass, and more preferably from 0.0001 to 0.3 parts by mass, based on 100 parts by mass of the silane-modified resin.

The silanol condensation catalyst is preferably used as a silanol condensation catalyst-containing master batch in which a resin and a silanol condensation catalyst are blended. Examples of the resin that can be used for this silanol condensation catalyst-containing master batch include a polyolefin. A polyethylene, a polypropylene, a copolymer of these, and the like are preferred.

In a case where the silanol condensation catalyst is used as the silanol condensation catalyst-containing master batch in which a resin and a silanol condensation catalyst are blended, the content of the silanol condensation catalyst in the master batch is preferably, but not limited to, from 0.1 to 5.0 mass %. A commercially available product can be used as the silanol condensation catalyst-containing master batch, and, for example, “PZ010”, available from Mitsubishi Chemical Corporation, can be used.

The resin composition constituting the outer layer preferably contains an anti-aging agent. Blending of the anti-aging agent makes extrusion moldability during molding of a resin composition before crosslinking good.

Examples of the anti-aging agent include, but not limited to, a hindered phenol-based antioxidant, a phenol-based antioxidant, an amine-based antioxidant, a phosphorus-based heat stabilizer, a metal deactivator, and a sulfur-based heat resistant stabilizer, and a hindered phenol-based antioxidant is preferred, and a hindered phenol-based antioxidant having a pentaerythritol ester structure is more preferred. Specific examples of the hindered phenol-based antioxidant include IRGANOX (trade name) 1010 (pentaerythritol tetrakis[3-(3,5-di-tert-butyl-4-hydroxyphenyl)propionate]), available from BASF Japan Ltd.

The content of the anti-aging agent is preferably from 1 to 10 parts by mass, more preferably from 2 to 8 parts by mass, and even more preferably from 3 to 7 parts by mass based on 100 parts by mass of the polyisobutylene-backbone-bearing elastomer.

The resin composition constituting the outer layer can contain an elastomer other than the polyisobutylene-backbone-bearing elastomer, a resin other than the crosslinked resin, and an additive other than the silanol condensation catalyst and the anti-aging agent in a range in which the effects of the present technology are not impaired.

The resin composition constituting the outer layer may have any phase structure but preferably has a sea-island structure or a co-continuous structure, and more preferably has a sea-island structure composed of a matrix (sea phase) containing the crosslinked resin and a domain (island phase) containing the polyisobutylene-backbone-bearing elastomer, the domain being dispersed in the matrix.

The matrix is preferably crosslinked. The crosslinking of the matrix contributes to heat resistance.

The domain is preferably crosslinked. The crosslinking of the domain contributes to heat resistance.

More preferably, both the matrix and the domain are crosslinked.

In a case of the co-continuous structure, excellent flexibility is achieved. The water vapor permeability of the resin composition constituting the outer layer is 3.0 g·mm/(m²·24 h) or less, preferably 2.5 g·mm/(m²·24 h) or less, and more preferably 2.0 g·mm/(m²·24 h) or less.

When the water vapor permeability is too high, moisture in the outside air penetrates into the refrigerant-transporting hose and can cause freezing of moisture inside the air conditioner. An embodiment of the present technology effectively blocks the intrusion of moisture from the outside by using, as the material constituting the outer layer, a material that is less likely to allow the permeation of water vapor.

A water vapor permeability coefficient is defined as follows. The water vapor permeability coefficient is an amount of water vapor that permeates a thickness of 1 mm per 1 m² of surface area in 24 hours under stipulated temperature and humidity conditions.

The water vapor permeability is measured at a temperature of 60° C. and a relative humidity of 95% by using a water vapor permeability tester.

The resin composition constituting the outer layer has TB₁₅₀, a strength at break at 150° C., of preferably 1.0 MPa or more, more preferably from 1.2 to 30 MPa, and even more preferably from 1.5 to 25 MPa. The degree of crosslinking of the rubber is important for setting the strength at break at 150° C., TB₁₅₀, of the resin composition within the above numerical range.

The strength at break can be measured in accordance with the measurement method specified in JIS (Japanese Industrial Standard) K 6251 “Rubber, vulcanized or thermoplastics—Determination of tensile stress-strain properties”.

The reinforcing layer is, for example, a layer of braided fibers, without limitation.

The reinforcing layer preferably contains, a polyester fiber, a polyamide fiber, an aramid fiber, a PBO (poly(p-phenylene benzobisoxazole)) fiber, a vinylon fiber, or a rayon fiber, without limitation.

The inner layer is preferably composed of a thermoplastic resin composition containing 100 parts by mass of an elastomer and from 30 to 170 parts by mass of a thermoplastic resin, without limitation: the thermoplastic resin composition has a sea-island structure in which the elastomer is present as a domain in a matrix containing the thermoplastic resin: the thermoplastic resin contains from 50 to 100 parts by mass of a polyamide based on 100 parts by mass of the thermoplastic resin: the elastomer contains a polyisobutylene-backbone-bearing elastomer; and the thermoplastic resin composition further contains a phenylenediamine-based or quinoline-based anti-aging agent and a processing aid.

The thermoplastic resin constituting the matrix of the thermoplastic resin composition constituting the inner layer contains preferably from 50 to 100 parts by mass of a polyamide based on 100 parts by mass of the thermoplastic resin, more preferably from 75 to 100 parts by mass of a polyamide based on 100 parts by mass of the thermoplastic resin, and even more preferably from 95 to 100 parts by mass of a polyamide based on 100 parts by mass of the thermoplastic resin, without limitation. When the polyamide is contained in an amount within the numerical range described above, gas barrier properties can be ensured.

Examples of the polyamide include nylon 6, nylon 66, nylon 11, nylon 12, nylon 610, a nylon 6/66 copolymer, a nylon 6/12 copolymer, nylon 46, nylon 6T, nylon 9T, and nylon MXD6, and of these, nylon 6 and a nylon 6/12 copolymer are preferred.

The thermoplastic resin constituting the matrix of the thermoplastic resin composition constituting the inner layer can contain a resin other than the polyamide. Examples of the resin other than the polyamide include, but not limited to, a polyester, a polyvinylalcohol, and a polyketone.

The elastomer constituting the domain of the thermoplastic resin composition constituting the inner layer contains a polyisobutylene-backbone-bearing elastomer. The polyisobutylene-backbone-bearing elastomer is as described above.

The content of the thermoplastic resin in the thermoplastic resin composition constituting the inner layer is preferably from 30 to 170 parts by mass, more preferably from 35 to 169 parts by mass, and even more preferably from 40 to 100 parts by mass, based on 100 parts by mass of the elastomer in the thermoplastic resin composition constituting the inner layer. When the content of the elastomer is in the numerical range described above, the dispersion state of the sea-island structure, in which the elastomer is the domain, can be ensured, and flexibility and gas barrier properties can be ensured.

The thermoplastic resin composition constituting the inner layer preferably contains a phenylenediamine-based or quinoline-based anti-aging agent. When the thermoplastic resin composition contains a phenylenediamine-based or quinoline-based anti-aging agent, heat aging resistance is improved.

The phenylenediamine-based anti-aging agent refers to an anti-aging agent having, in the molecular structure thereof, an aromatic ring having two secondary amines as substituents, and is preferably at least one type selected from the group consisting of N-phenyl-N′-(1,3-dimethylbutyl)-p-phenylenediamine, N-phenyl-N′-(1-methylheptyl)-p-phenylenediamine, N-phenyl-N′-isopropyl-p-phenylenediamine, N,N′-di-2-naphthyl-p-phenylenediamine, and N,N′-diphenyl-p-phenylenediamine, and is more preferably N-phenyl-N′-(1,3-dimethylbutyl)-p-phenylenediamine.

The quinoline-based anti-aging agent refers to an anti-aging agent having a quinoline backbone in the molecular structure, and is preferably a 2,2,4-trimethyl-1,2-dihydroquinoline polymer.

The content of the phenylenediamine-based anti-aging agent or the quinoline-based anti-aging agent in the thermoplastic resin composition constituting the inner layer (when both the phenylenediamine-based anti-aging agent and the quinoline-based anti-aging agent are contained, the total content of the phenylenediamine-based anti-aging agent and the quinoline-based anti-aging agent) is preferably from 0.1 to 10 parts by mass, and more preferably from 0.1 to 5.0 parts by mass based on 100 parts by mass of the total amount of the thermoplastic resin and the elastomer.

The thermoplastic resin composition constituting the inner layer preferably contains a processing aid. The processing aid contributes to improvement in extrudability of the thermoplastic resin composition.

The processing aid is not particularly limited but is preferably at least one type selected from a fatty acid, a fatty acid metal salt, a fatty acid ester, and a fatty acid amide.

Examples of the fatty acid include stearic acid, palmitic acid, lauric acid, oleic acid, and linoleic acid, and stearic acid is preferred.

Examples of the fatty acid metal salt include calcium stearate, potassium stearate, zinc stearate, magnesium stearate, and sodium stearate, and calcium stearate is preferred.

Examples of the fatty acid ester include glycerin monostearate, sorbitan stearate, stearyl stearate, and ethylene glycol distearate.

Examples of the fatty acid amide include stearic acid monoamides, oleic acid monoamides, and ethylene bis stearic acid amides.

The content of the processing aid in the thermoplastic resin composition constituting the inner layer is preferably from 0.2 to 10 parts by mass, more preferably from 1 to 8 parts by mass, and even more preferably from 1 to 5 parts by mass, based on 100 parts by mass of the total amount of the thermoplastic resin and the elastomer.

The thermoplastic resin composition constituting the inner layer preferably contains a viscosity stabilizer. Blending of the viscosity stabilizer suppresses an increase in viscosity during extrusion molding of the thermoplastic resin composition, and can effectively reduce the occurrence of residual matter, and thus processability is improved.

Examples of the viscosity stabilizer include a divalent metal oxide, an ammonium salt, and a carboxylate.

Examples of the divalent metal oxide include zinc oxide, magnesium oxide, copper oxide, calcium oxide, and iron oxide. The divalent metal oxide is preferably zinc oxide or magnesium oxide, and more preferably zinc oxide.

Examples of the ammonium salt include ammonium carbonate, ammonium bicarbonate, ammonium chloride, ammonium bromide, ammonium sulfate, ammonium nitrate, ammonium acetate, and alkylammonium.

Examples of the carboxylate include sodium acetate, potassium acetate, zinc acetate, copper acetate, sodium oxalate, ammonium oxalate, calcium oxalate, and iron oxalate.

The viscosity stabilizer is most preferably zinc oxide.

The content of the viscosity stabilizer in the thermoplastic resin composition constituting the inner layer is preferably from 0.1 to 30 parts by mass, more preferably from 0.5 to 20 parts by mass, and even more preferably from 0.5 to 5 parts by mass, based on 100 parts by mass of the total amount of the thermoplastic resin and the elastomer.

Preferably, 50 mass % or more of the viscosity stabilizer is contained in the matrix. Blending of 50 mass % or more of the viscosity stabilizer in the matrix suppresses an increase in viscosity during extrusion molding of the thermoplastic resin composition, and can effectively reduce the occurrence of residual matter, and thus processability is improved.

The thermoplastic resin composition constituting the inner layer may contain various additives other than the components described above.

The method for manufacturing the refrigerant-transporting hose is not particularly limited, and the refrigerant-transporting hose can be manufactured as follows. First, the inner layer is extruded into a tube shape by extrusion molding, then a fiber which is to serve as a reinforcing layer is braided on the tube, and further the fiber is covered with an outer layer by extrusion molding of the outer layer on the fiber.

The method for manufacturing the refrigerant-transporting hose according to an embodiment of the present technology preferably includes: preparing a composition for an outer layer by melt-kneading a polyisobutylene-backbone-bearing elastomer, a crosslinkable resin, and a crosslinking agent for the polyisobutylene-backbone-bearing elastomer; and adding a silanol condensation catalyst to the composition for an outer layer during extrusion molding of a hose and forming an outer layer by performing extrusion molding of a composition to which the silanol condensation catalyst is added.

The crosslinkable resin refers to a resin before crosslinking of the above-described crosslinked resin. The crosslinkable resin is preferably the above-described silane-modified resin.

Hereinafter, the preparing a composition for an outer layer by melt-kneading a polyisobutylene-backbone-bearing elastomer, a crosslinkable resin, and a crosslinking agent for the polyisobutylene-backbone-bearing elastomer is also simply referred to as “melt-kneading step”.

The melt-kneading is not limited but may be performed by using a kneader, a single screw or twin screw extruder, or the like.

The temperature during the melt-kneading is not limited as long as the melt-kneading can be performed but is preferably from 170 to 240° C.

The time for the melt-kneading is not limited as long as the target kneaded material can be prepared but is preferably from 2 to 10 minutes.

In the melt-kneading step, the polyisobutylene-backbone-bearing elastomer, the crosslinkable resin and the crosslinking agent for the polyisobutylene-backbone-bearing elastomer, and, optionally, various additives such as an anti-aging agent, a processing aid, and a viscosity stabilizer, are charged in a kneader or the like and melt-kneaded.

However, the silanol condensation catalyst is preferably not added in the melt-kneading step. In a case where the silanol condensation catalyst is added in the melt-kneading step, when the composition for an outer layer prepared in the melt-kneading step is brought into contact with water vapor in the atmosphere, the crosslinkable resin in the composition for an outer layer gradually crosslinks, and molding of the composition for an outer layer after the crosslinking is thus difficult. Therefore, the silanol condensation catalyst is preferably added to the composition for an outer layer during molding.

Hereinafter, the phrase “adding a silanol condensation catalyst to the composition for an outer layer during extrusion molding of a hose and forming an outer layer by performing extrusion molding of a composition to which the silanol condensation catalyst is added” is also simply referred to as “outer layer forming step”.

“During extrusion molding” refers to simultaneously with the extrusion molding or within 6 hours prior to the extrusion molding.

The extrusion molding can be performed by using an extruder without limitation, and is preferably performed by using a twin screw extruder.

The silanol condensation catalyst may be added to the composition for an outer layer before charging the composition into the extruder, the composition for an outer layer and the silanol condensation catalyst may be charged into the extruder at the same time, or the composition for an outer layer and the silanol condensation catalyst may be charged into separate feeding ports of the extruder.

The silanol condensation catalyst may be directly added to the composition for an outer layer but is preferably added as a silanol condensation catalyst-containing master batch in which a resin and a silanol condensation catalyst are blended.

An outer layer is formed by extrusion molding of the composition, to which the silanol condensation catalyst has been added, onto an outer surface of the reinforcing layer.

The conditions of the extrusion molding are not limited, as long as the outer layer can be formed.

The method for manufacturing the refrigerant-transporting hose according to an embodiment of the present technology preferably includes a step of bringing the outer layer into contact with water or water vapor after the outer layer forming step to crosslink the matrix in the resin composition constituting the outer layer (hereinafter, also simply referred to as “water contact step”). Performing the water contact step improves heat resistance of the outer layer because the crosslinkable resin in the resin composition constituting the outer layer crosslinks.

Although the crosslinkable resin in the outer layer formed by the outer layer forming step gradually crosslinks when brought into contact with water vapor in the atmosphere to form a crosslinked resin and the outer layer is crosslinked, the water contact step is preferably performed in a case where rapid crosslinking of the outer layer is desired.

Examples of the method for bringing into contact with water or water vapor include, but not limited to, a method for soaking in a water bath, a method for spraying water, and a method for placing in an atmosphere containing water vapor but is preferably a method for placing in an atmosphere containing water vapor. In the method for placing in an atmosphere containing water vapor, the outer layer is allowed to stand still in the air at a temperature of from room temperature to 200° C., and preferably from room temperature to 100° C., and a relative humidity of from 30 to 100%, and preferably from 40 to 90%, for from 1 minute to 1 month, preferably from 1 hour to 1 week, and more preferably from 1 to 4 days. More specifically, the outer layer is preferably allowed to stand still in the air at a temperature of 25° C. and a relative humidity of 50% for 72 hours or longer.

In a case where the crosslinkable resin is a silane-modified resin, due to the water contact step, a hydrolyzable silyl group (preferably an alkoxysilyl group) in the silane-modified resin in the outer layer is hydrolyzed to form a silanol group, silanol groups undergo a condensation reaction to form a siloxane bond (Si—O—Si) to crosslink, and thus a crosslinked outer layer is obtained.

### EXAMPLES

### Raw Materials

The raw materials used in the following Examples and Comparative Examples are as follows.

### Raw Material for Outer Layer

IIR: Butyl rubber “Exxon Butyl” 268, available from ExxonMobil Chemical Co.

Br-IIR: Brominated butyl rubber “Exxon Bromobutyl” 2255, available from ExxonMobil Chemical Co.

Crosslinkable resin: Silane-modified polypropylene “Linklon” (trade name) XPM800HM, available from Mitsubishi Chemical Corporation

Polypropylene: Propylene homopolymer “Prime Polypro” (trade name) J108M, available from Prime Polymer Co., Ltd.

PP/EPDM: PP/EPDM thermoplastic elastomer “Santoprene” (trade name) 111-35, available from ExxonMobil Japan G.K.

Resin-based crosslinking agent-1: Alkylphenol-formaldehyde resin “Hitanol” (trade name) 2501Y, available from Hitachi Chemical Co., Ltd.

Resin-based crosslinking agent-2: Brominated alkylphenol-formaldehyde resin “Tackirol” (trade name) 250-I, available from Taoka Chemical Co., Ltd.

Zinc oxide: Zinc Oxide III, available from Seido Chemical Industry Co., Ltd.

Silanol condensation catalyst: Silane crosslinking agent master batch “Catalyst MB” PZ010, available from Mitsubishi Chemical Corporation

Anti-aging agent-1: Hindered phenol-based antioxidant “IRGANOX” (trade name) 1010, available from BASF Japan Ltd.

### Raw Material for Inner Layer

Butyl rubber: Brominated isobutylene-p-methylstyrene copolymer rubber “EXXPRO” (trade name) 3745, available from ExxonMobil Chemical Co.

Nylon 6: Nylon 6 “UBE Nylon” (trade name) 1011FB, available from Ube Industries, Ltd.

Nylon 6/12: Nylon 6/12 copolymer “UBE Nylon” (trade name) 7024B, available from Ube Industries, Ltd.

Anti-aging agent-2: Phenylenediamine-based anti-aging agent “SANTOFLEX” (trade name) 6PPD, available from Solutia Inc. (substance name: N-phenyl-N′-(1,3-dimethylbutyl)-p-phenylenediamine)

Viscosity stabilizer: Zinc Oxide III, available from Seido Chemical Industry Co., Ltd.

Processing aid-1: Industrial stearic acid, available from Chiba Fatty Acid Co., Ltd.

Processing aid-2: Calcium stearate SC-PG, available from Sakai Chemical Industry Co., Ltd.

### Preparation of Resin Composition for Outer Layer

Resin compositions for outer layers A1 to A11, A′1 and A′2 were prepared by the following method. The raw materials other than the silanol condensation catalyst were charged into a twin screw extruder (available from The Japan Steel Works, Ltd.) at the compounding ratios listed in Table 1, and kneaded for three minutes at 235° C. The kneaded product was extruded continuously in a strand-like form from the extruder, cooled with water, and then cut with a cutter. Thus, each of the resin compositions for outer layers A1 to A11, A′1 and A′2 in a pellet form was obtained. The silanol condensation catalyst was added during sheet formation by an extruder in a case of measurement and evaluation of water vapor permeability, flexibility, extrudability and strength at break. The silanol condensation catalyst was added during tube shape extrusion of the resin composition for an outer layer in a case of production of a refrigerant-transporting hose.

As the resin composition for an outer layer A′3, a commercially available PP/EPDM thermoplastic elastomer “Santoprene” (trade name) 111-35 (thermoplastic elastomer in which the matrix was a polypropylene and the domain was an ethylene-propylene-diene copolymer) was used.

For the resin compositions for outer layers A1 to A11 and A′1 to A′3, the water vapor permeability, flexibility, extrudability, and strength at break at 150° C., TB₁₅₀, were measured and evaluated. The measurement and evaluation results are listed in Table 1.

### Preparation of Thermoplastic Resin Composition for Inner Layer

The raw materials were charged into a twin screw extruder (available from The Japan Steel Works, Ltd.) at the compounding ratios listed in Table 2, and kneaded for three minutes at 235° C. The kneaded product was extruded continuously in a strand-like form from the extruder, cooled with water, and then cut with a cutter. And thus, each of the thermoplastic resin compositions for inner layers B1 to B4 in a pellet form was obtained.

### Preparation of Refrigerant-Transporting Hose

The thermoplastic resin composition for an inner layer was extruded by an extruder into a tube shape having a thickness listed in Tables 3 to 5 onto a mandrel coated in advance with a release agent. A reinforcing yarn of polyester was braided thereon using a braiding machine, after which the resin composition for an outer layer, in which the silanol condensation catalyst was added, was extruded, by an extruder, onto the reinforcing yarn in a tube shape having a thickness listed in Tables 3 to 5, the mandrel was removed, and thereby a hose consisting of an inner layer, a reinforcing layer, and an outer layer was produced.

After the resin composition for an outer layer was crosslinked by allowing the produced hose to stand still in the air at a temperature of 25° C. and a relative humidity of 50% for 72 hours or longer, heat resistance, moisture permeation resistance, refrigerant permeation resistance, and flexibility were evaluated. The evaluation results are listed in Tables 3 to 5.

The measurement and evaluation methods are as follows.

### Measurement of Water Vapor Permeability

A sample of the resin composition for an outer layer, in which the silanol condensation catalyst was added, was formed into a sheet with an average thickness of 0.2 mm by using a 40 mmØ single screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min. The produced sheet was allowed to stand still in the air at a temperature of 25° C. and a relative humidity of 50% for 72 hours or longer, and thus a sheet of the crosslinked resin composition was produced.

The obtained sheet was cut out, and the water vapor permeability was measured at a temperature of 60° C. and a relative humidity of 95% by using a water vapor permeation tester available from GTR Tec Corporation.

Evaluation of Flexibility of Resin composition for Outer Layer

The crosslinked sheet having an average thickness of 0.2 mm prepared for measurement of the water vapor permeability was punched out into a JIS No. 3 dumbbell shape and subjected to tensile tests in a condition at a temperature of 25° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at 10% elongation (10% modulus) was determined.

The 10% modulus is an indicator of flexibility, and a smaller 10% modulus indicates superior flexibility. The flexibility was evaluated as ◯ when the 10% modulus was 10 MPa or less, and evaluated as x when the 10% modulus was more than 10 MPa.

### Evaluation of Extrudability

A sample of the resin composition for an outer layer, in which the silanol condensation catalyst was added, was formed into a sheet with an average thickness of 0.2 mm by using a 40 mmØ single screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min. A case where molding had no problem was evaluated as “∘”, a case where slight lump or hole or cutting of a sheet edge occurred was evaluated as “Δ”, and a case where serious lump or hole or cutting of a sheet edge occurred was evaluated as “x”.

### Measurement of Strength at Break

The sheet having the average thickness of 0.2 mm produced in the measurement of water vapor permeability was allowed to stand still in the air at a temperature of 25° C. and a relative humidity of 50% for 72 hours or longer, and thus a sheet of the crosslinked resin composition was produced. The sheet of the crosslinked resin composition was punched out into a JIS No. 3 dumbbell shape and subjected to tensile tests in a condition at a temperature of 150° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at break was determined, and defined as a strength at break at 150° C., TB₁₅₀.

### Evaluation of Heat Resistance

Sealing properties of the swaging part after heat aging were confirmed by an air tightness test, in which the test sample allowed to stand in an oven at 150° C. for 240 hours was pressurized to an internal pressure of 3.5 MPa and maintained for five minutes. A case where no leakage occurred was evaluated as ◯, and a case where leakage occurred was evaluated as x.

### Evaluation of Moisture Permeation Resistance

Each of the test samples that had been left in an oven at 50° C. for 5 hours was filled with a drying agent having a volume corresponding to 80% of the inner volume of the test sample and was then sealed. The test sample was then left to stand in an atmosphere with a temperature of 50° C. and a relative humidity of 95%, the increase amount of the mass of the drying agent from after 120 hours to after 360 hours was measured, the increase amount of the mass during the 240-hour period was divided by the inner surface area of the test sample, and the water vapor permeability coefficient [mg/(240 h·cm²)] was calculated. A smaller numerical value of the water vapor permeability coefficient indicates superior moisture permeation resistance. A case where this numerical value was 3 or less can be evaluated as having moisture permeation resistance adequate for practical use. In Tables 3 to 5, a case where this numerical value was 3 or less was evaluated as ◯, and a case where this numerical value was more than 3 was evaluated as x.

### Evaluation of Refrigerant Permeation Resistance

The measurement was performed in accordance with SAE J2064 AUG2015. Test samples having a length of 1.07 m were each filled with a refrigerant (HFO-1234yf) at an amount of 70%±3% per 1 cm³ of the internal volume of the test sample. This test sample was allowed to stand in an atmosphere at 80° C. for 25 days, and an amount of reduction in the mass (amount of refrigerant permeation) per day [kg/day] was measured for a predetermined period (five days to seven days) at the end of the 25-day period. A numerical value obtained by dividing this amount of reduction by an inner surface area of the test sample was converted into a numerical value per year to calculate a refrigerant permeation coefficient [kg/(m²·year)]. A smaller numerical value of the refrigerant permeation coefficient indicates superior refrigerant permeation resistance. A case where this numerical value was 3 or less can be evaluated as having refrigerant permeation resistance adequate for practical use. In Tables 3 to 5, a case where this numerical value was 3 or less was evaluated as ◯, and a case where this numerical value was more than 3 was evaluated as x.

### Evaluation of Flexibility of Hose

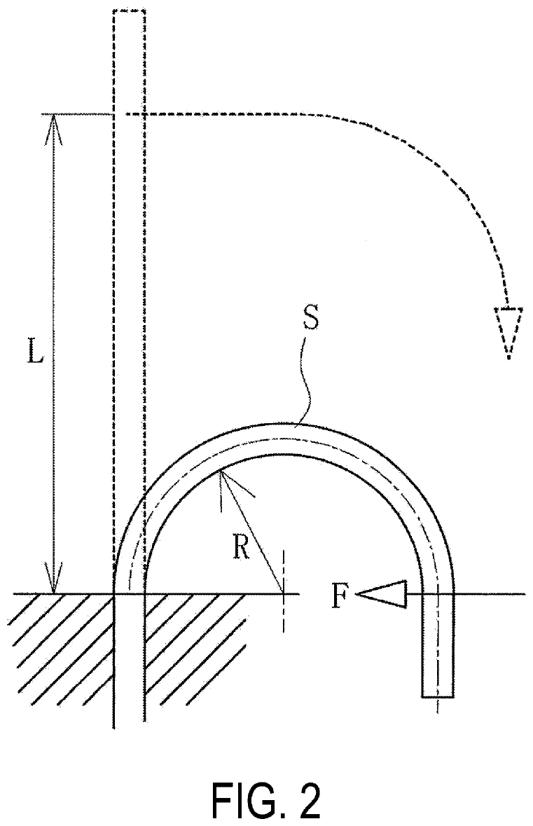

As illustrated in FIG. 2, one end portion in a length direction of each of the test samples S was fixed by a fixing tool such as a clamp, a spring balance was attached to the other end portion which was separated from the fixing position by a predetermined length L (120+hose outer diameter/2)×π [mm] and pulled, and the test sample S was bent in a semicircular arc-shape from a state illustrated by dashed lines to a state illustrated by solid lines. Then, a tensile force F measured by the spring balance that was pulling in a horizontal direction in a bent state with a radius R in a hose inner side of 120 mm was used as an indicator for evaluation. A smaller value of this tensile force F indicates ease in bending and superior flexibility of the test sample S. A case where this tensile force F was 20 N or less can be evaluated as having flexibility adequate for practical use. In Tables 3 to 5, a case where this tensile force F was 20 N or less was evaluated as ◯, and a case where this tensile force F was more than 20 N was evaluated as x.

TABLE 1-1
Compounding proportion of resin composition for outer layer

| | | A1 | A2 | A3 | A4 | A5 | A6 | A7 | A8 |
|---|---|---|---|---|---|---|---|---|---|
| IIR | parts | 100 | 100 | 100 | 100 | 100 | 100 | 100 | |
| | by mass | | | | | | | | |
| Br-IIR | parts | | | | | | | | 100 |
| | by mass | | | | | | | | |
| Cross- | parts | 30 | 21 | 22 | 18 | 21 | 21 | 21 | 21 |
| linkable | by mass | | | | | | | | |
| resin | | | | | | | | | |
| Polypropylene | parts | 30 | 21 | 22 | 18 | 21 | 21 | 21 | 21 |
| | by mass | | | | | | | | |
| PP/EPDM | parts | | | | | | | | |
| | by mass | | | | | | | | |
| Resin-based | parts | 5 | 9 | 9 | 5 | 5 | 5 | 2 | 2 |
| crosslinking | by mass | | | | | | | | |
| agent-1 | | | | | | | | | |
| Resin-based | parts | | | | | | | | |
| crosslinking | by mass | | | | | | | | |
| agent-2 | | | | | | | | | |
| Zinc oxide | parts | 6 | 6 | 6 | 6 | 3 | 8 | 6 | 6 |
| | by mass | | | | | | | | |
| Silanol | parts | 2 | 2 | 2 | 2 | 2 | 2 | 2 | 2 |
| condensation | by mass | | | | | | | | |
| catalyst | | | | | | | | | |
| Anti-aging | parts | 5 | | 5 | 5 | 5 | 5 | 5 | 5 |
| agent-1 | by mass | | | | | | | | |
| Water vapor | g · mm/ | 1.6 | 1.5 | 1.5 | 1.4 | 1.5 | 1.6 | 1.6 | 1.5 |
| permeability | (m² · 24 h) | | | | | | | | |
| Flexibility | | ◯ | ◯ | ◯ | ◯ | ◯ | ◯ | ◯ | ◯ |
| Extrudability | | ◯ | Δ | ◯ | ◯ | ◯ | ◯ | ◯ | ◯ |
| TB₁₅₀ | | 2.5 | 2.4 | 2.6 | 2.0 | 2.0 | 2.0 | 1.9 | 2.3 |

TABLE 1-2
Compounding proportion of resin composition for outer layer

| | | A9 | A10 | A11 | A′1 | A′2 | A′3 |
|---|---|---|---|---|---|---|---|
| IIR | parts | | | | | | |
| | by mass | | | | | | |
| Br-IIR | parts | 100 | 100 | 100 | 100 | 100 | |
| | by mass | | | | | | |
| Cross- | parts | 30 | 45 | 20 | | 52 | |
| linkable | by mass | | | | | | |
| resin | | | | | | | |
| Polypropylene | parts | 30 | | 20 | 41 | | |
| | by mass | | | | | | |
| PP/EPDM | parts | | | | | | 100 |
| | by mass | | | | | | |
| Resin-based | parts | 2 | | | | | |
| crosslinking | by mass | | | | | | |
| agent-1 | | | | | | | |
| Resin-based | parts | | 9 | 2 | | | |
| crosslinking | by mass | | | | | | |
| agent-2 | | | | | | | |
| Zinc oxide | parts | 6 | 8 | 3 | 2 | 2 | |
| | by mass | | | | | | |
| Silanol | parts | 2 | 2 | 2 | | 3 | |
| condensation | by mass | | | | | | |
| catalyst | | | | | | | |
| Anti-aging | parts | 5 | 5 | 5 | 5 | 5 | |
| agent-1 | by mass | | | | | | |
| Water vapor | g · mm/ | 1.5 | 1.9 | 1.7 | 1.5 | 1.6 | 14.1 |
| permeability | (m² · 24 h) | | | | | | |
| Flexibility | | ◯ | ◯ | ◯ | ◯ | ◯ | ◯ |
| Extrudability | | ◯ | ◯ | ◯ | ◯ | ◯ | ◯ |
| TB₁₅₀ | | 3.2 | 1.7 | 1.7 | Unmea- | 0.5 | 0.2 |
| | | | | | surable | | |

TABLE 2
Compounding proportion of thermoplastic
resin composition for inner layer

| | | B1 | B2 | B3 | B4 |
|---|---|---|---|---|---|
| Butyl-based rubber | parts by mass | 100 | 100 | 100 | 100 |
| Nylon 6 | parts by mass | 169 | 74 | 51 | 29 |
| Nylon 6/12 | parts by mass | 0 | 0 | 8 | 5 |
| Anti-aging agent-2 | parts by mass | 4 | 3 | 3 | 3 |
| Viscosity stabilizer | parts by mass | 9 | 6 | 5 | 5 |
| Processing aid-1 | parts by mass | 2 | 1 | 1 | 1 |
| Processing aid-2 | parts by mass | 2 | 1 | 1 | 1 |

TABLE 3-1
Configuration and evaluation of hose (1)

| | | | Exam- | Exam- | Exam- | Exam- | Exam- |
|---|---|---|---|---|---|---|---|
| | | | ple 1 | ple 2 | ple 3 | ple 4 | ple 5 |
| Inner layer | Composition | | B3 | B3 | B3 | B3 | B3 |
| | Layer thickness | mm | 0.4 | 0.8 | 0.4 | 0.4 | 0.4 |
| Reinforcing | Material | | Polyester | Polyester | Polyester | Polyester | Polyester |
| layer | Layer thickness | mm | 1.0 | 1.0 | 1.0 | 1.0 | 1.0 |
| | Inclination angle | ° | 54.7 | 54.7 | 53 | 56 | 54.7 |
| | Structure | | Braided | Braided | Braided | Braided | Spiral |
| | Number of layers | | 1 | 1 | 1 | 1 | 2 |
| Outer layer | Composition | | A7 | A7 | A7 | A7 | A7 |
| | Layer thickness | mm | 1.2 | 1.2 | 1.2 | 1.2 | 1.2 |
| Evaluation | Heat resistance | | ◯ | ◯ | ◯ | ◯ | ◯ |
| | Moisture | | ◯ | ◯ | ◯ | ◯ | ◯ |
| | permeation | | | | | | |
| | resistance | | | | | | |
| | Refrigerant | | ◯ | ◯ | ◯ | ◯ | ◯ |
| | permeation | | | | | | |
| | resistance | | | | | | |
| | Flexibility | | ◯ | ◯ | ◯ | ◯ | ◯ |

TABLE 3-2
Configuration and evaluation of hose (1)

| | | | Exam- | Exam- | Exam- | Exam- |
|---|---|---|---|---|---|---|
| | | | ple 6 | ple 7 | ple 8 | ple 9 |
| Inner layer | Composition | | B3 | B3 | B2 | B2 |
| | Layer thickness | mm | 0.4 | 0.4 | 0.4 | 0.8 |
| Reinforcing | Material | | Polyester | Polyester | Polyester | Polyester |
| layer | Layer thickness | mm | 1.0 | 1.0 | 1.0 | 1.0 |
| | Inclination angle | ° | 53 | 56 | 54.7 | 54.7 |
| | Structure | | Spiral | Spiral | Braided | Braided |
| | Number of layers | | 2 | 2 | 1 | 1 |
| Outer layer | Composition | | A7 | A7 | A7 | A7 |
| | Layer thickness | mm | 1.2 | 1.2 | 1.2 | 1.2 |
| Evaluation | Heat resistance | | ◯ | ◯ | ◯ | ◯ |
| | Moisture | | ◯ | ◯ | ◯ | ◯ |
| | permeation | | | | | |
| | resistance | | | | | |
| | Refrigerant | | ◯ | ◯ | ◯ | ◯ |
| | permeation | | | | | |
| | resistance | | | | | |
| | Flexibility | | ◯ | ◯ | ◯ | ◯ |

TABLE 4-1
Configuration and evaluation of hose (2)

| | | | Exam- | Exam- | Exam- | Exam- | Exam- |
|---|---|---|---|---|---|---|---|
| | | | ple 10 | ple 11 | ple 12 | ple 13 | ple 14 |
| Inner layer | Composition | | B1 | B1 | B3 | B2 | B1 |
| | Layer thickness | mm | 0.4 | 0.8 | 0.4 | 0.4 | 0.4 |
| Reinforcing | Material | | Polyester | Polyester | Polyester | Polyester | Polyester |
| layer | Layer thickness | mm | 1.0 | 1.0 | 1.0 | 1.0 | 1.0 |
| | Inclination angle | ° | 54.7 | 54.7 | 54.7 | 54.7 | 54.7 |
| | Structure | | Braided | Braided | Braided | Braided | Braided |
| | Number of layers | | 1 | 1 | 1 | 1 | 1 |
| Outer layer | Composition | | A7 | A7 | A4 | A4 | A4 |
| | Layer thickness | mm | 1.2 | 1.2 | 1.2 | 1.2 | 1.2 |
| Evaluation | Heat resistance | | ◯ | ◯ | ◯ | ◯ | ◯ |
| | Moisture | | ◯ | ◯ | ◯ | ◯ | ◯ |
| | permeation | | | | | | |
| | resistance | | | | | | |
| | Refrigerant | | ◯ | ◯ | ◯ | ◯ | ◯ |
| | permeation | | | | | | |
| | resistance | | | | | | |
| | Flexibility | | ◯ | Δ | ◯ | ◯ | ◯ |

TABLE 4-2
Configuration and evaluation of hose (2)

| | | | Exam- | Exam- | Exam- | Exam- |
|---|---|---|---|---|---|---|
| | | | ple 15 | ple 16 | ple 17 | ple 18 |
| Inner layer | Composition | | B3 | B3 | B3 | B3 |
| | Layer thickness | mm | 0.4 | 0.4 | 0.4 | 0.4 |
| Reinforcing | Material | | Polyester | Polyester | Polyester | Polyester |
| layer | Layer thickness | mm | 1.0 | 1.0 | 1.0 | 1.0 |
| | Inclination angle | ° | 54.7 | 54.7 | 54.7 | 54.7 |
| | Structure | | Braided | Braided | Braided | Braided |
| | Number of layers | | 1 | 1 | 1 | 1 |
| Outer layer | Composition | | A2 | A3 | A5 | A6 |
| | Layer thickness | mm | 1.2 | 1.2 | 1.2 | 1.2 |
| Evaluation | Heat resistance | | ◯ | ◯ | ◯ | ◯ |
| | Moisture | | ◯ | ◯ | ◯ | ◯ |
| | permeation | | | | | |
| | resistance | | | | | |
| | Refrigerant | | ◯ | ◯ | ◯ | ◯ |
| | permeation | | | | | |
| | resistance | | | | | |
| | Flexibility | | ◯ | ◯ | ◯ | ◯ |

TABLE 5-1
Configuration and evaluation of hose (3)

| | | | Exam- | Exam- | Exam- | Exam- | Exam- |
|---|---|---|---|---|---|---|---|
| | | | ple 19 | ple 20 | ple 21 | ple 22 | ple 23 |
| Inner layer | Composition | | B3 | B3 | B3 | B3 | B3 |
| | Layer thickness | mm | 0.4 | 0.4 | 0.4 | 0.4 | 0.4 |
| Reinforcing | Material | | Polyester | Polyester | Polyester | Polyester | Polyester |
| layer | Layer thickness | mm | 1.0 | 1.0 | 1.0 | 1.0 | 1.0 |
| | Inclination angle | ° | 54.7 | 54.7 | 54.7 | 54.7 | 54.7 |
| | Structure | | Braided | Braided | Braided | Braided | Braided |
| | Number of layers | | 1 | 1 | 1 | 1 | 1 |
| Outer layer | Composition | | A1 | A8 | A9 | A10 | A11 |
| | Layer thickness | mm | 1.2 | 1.2 | 1.2 | 1.2 | 1.2 |
| Evaluation | Heat resistance | | ◯ | ◯ | ◯ | ◯ | ◯ |
| | Moisture | | ◯ | ◯ | ◯ | ◯ | ◯ |
| | permeation | | | | | | |
| | resistance | | | | | | |
| | Refrigerant | | ◯ | ◯ | ◯ | ◯ | ◯ |
| | permeation | | | | | | |
| | resistance | | | | | | |
| | Flexibility | | ◯ | ◯ | ◯ | ◯ | ◯ |

TABLE 5-2
Configuration and evaluation of hose (3)

| | | | Exam- | Comparative | Comparative | Comparative |
|---|---|---|---|---|---|---|
| | | | ple 24 | Example 1 | Example 2 | Example 3 |
| Inner layer | Composition | | B4 | B3 | B3 | B3 |
| | Layer thickness | mm | 0.4 | 0.4 | 0.4 | 0.4 |
| Reinforcing | Material | | Polyester | Polyester | Polyester | Polyester |
| layer | Layer thickness | mm | 1.0 | 1.0 | 1.0 | 1.0 |
| | Inclination angle | 0 | 54.7 | 54.7 | 54.7 | 54.7 |
| | Structure | | Braided | Braided | Braided | Braided |
| | Number of layers | | 1 | 1 | 1 | 1 |
| Outer layer | Composition | | A4 | A′1 | A′2 | A′3 |
| | Layer thickness | mm | 1.2 | 1.2 | 1.2 | 1.2 |
| Evaluation | Heat resistance | | ◯ | X | X | X |
| | Moisture | | ◯ | ◯ | ◯ | X |
| | permeation | | | | | |
| | resistance | | | | | |
| | Refrigerant | | ◯ | ◯ | ◯ | ◯ |
| | permeation | | | | | |
| | resistance | | | | | |
| | Flexibility | | ◯ | ◯ | ◯ | ◯ |

The refrigerant-transporting hose of the present technology can be suitably used for transporting a refrigerant for an air conditioner and the like of an automobile and the like.

1. A refrigerant-transporting hose, comprising an outer layer, a reinforcing layer, and an inner layer, the outer layer comprising a resin composition comprising 100 parts by mass of a polyisobutylene-backbone-bearing elastomer, from 10 to 150 parts by mass of a crosslinked resin, and from 2.5 to 25 parts by mass of a crosslinking agent for the polyisobutylene-backbone-bearing elastomer, and the resin composition constituting the outer layer having a water vapor permeability of 3.0 g·mm/(m²·24 h) or less.

2. The refrigerant-transporting hose according to claim 1, wherein the crosslinking agent for the polyisobutylene-backbone-bearing elastomer comprises zinc oxide and an alkylphenol formaldehyde-based resin.

3. The refrigerant-transporting hose according to claim 1, wherein a content of the zinc oxide in the resin composition constituting the outer layer is from 1 to 10 parts by mass based on 100 parts by mass of the polyisobutylene-backbone-bearing elastomer, and a content of the alkylphenol formaldehyde-based resin is from 1.5 to 15 parts by mass based on 100 parts by mass of the polyisobutylene-backbone-bearing elastomer.

4. The refrigerant-transporting hose according to claim 1, wherein the polyisobutylene-backbone-bearing elastomer in the resin composition constituting the outer layer is butyl rubber or modified butyl rubber, and the polyisobutylene-backbone-bearing elastomer is dynamically crosslinked.

5. The refrigerant-transporting hose according to claim 1, wherein the crosslinked resin in the resin composition constituting the outer layer is a crosslinked silane-modified resin, the silane-modified resin being a silane compound modified thermoplastic resin.

6. The refrigerant-transporting hose according to claim 1, wherein the crosslinked resin in the resin composition constituting the outer layer is a crosslinked silane-modified polyolefin, the silane-modified polyolefin being a silane compound modified polyolefin.

7. The refrigerant-transporting hose according to claim 1, wherein the crosslinked resin in the resin composition constituting the outer layer is a crosslinked silane-modified polypropylene, the silane-modified polypropylene being a silane compound modified polypropylene.

8. The refrigerant-transporting hose according to claim 1, wherein the resin composition constituting the outer layer comprises from 1 to 10 parts by mass of an anti-aging agent based on 100 parts by mass of the polyisobutylene-backbone-bearing elastomer.

9. The refrigerant-transporting hose according to claim 1, wherein the resin composition constituting the outer layer has TB₁₅₀, a strength at break at 150° C., of 1.0 MPa or more.

10. The refrigerant-transporting hose according to claim 1, wherein the resin composition constituting the outer layer comprises a matrix and a domain, the matrix comprising the crosslinked resin and the domain comprising the polyisobutylene-backbone-bearing elastomer, the domain being dispersed in the matrix, and the matrix is crosslinked.

11. The refrigerant-transporting hose according to claim 1, wherein the resin composition constituting the outer layer comprises a matrix and a domain, the matrix comprising the crosslinked resin and the domain comprising the polyisobutylene-backbone-bearing elastomer, the domain being dispersed in the matrix, and the domain is crosslinked.

12. The refrigerant-transporting hose according to claim 1, wherein the inner layer comprises a thermoplastic resin composition comprising 100 parts by mass of an elastomer and from 30 to 170 parts by mass of a thermoplastic resin, the thermoplastic resin composition has a sea-island structure in which the elastomer is present as a domain in a matrix comprising the thermoplastic resin, the thermoplastic resin comprises from 50 to 100 parts by mass of a polyamide based on 100 parts by mass of the thermoplastic resin, the elastomer comprises a polyisobutylene-backbone-bearing elastomer, and the thermoplastic resin composition further comprises a phenylenediamine-based or quinoline-based anti-aging agent and a processing aid.

13. A method for manufacturing the refrigerant-transporting hose according to claim 1, the method comprising: preparing the resin composition for the outer layer by melt-kneading a polyisobutylene-backbone-bearing elastomer, a crosslinkable resin, and the crosslinking agent for the polyisobutylene-backbone-bearing elastomer; and adding a silanol condensation catalyst to the composition for the outer layer during extrusion molding of the hose and forming the outer layer by performing extrusion molding of the resin composition to which the silanol condensation catalyst is added.

14. The method according to claim 13, further comprising, after the step of forming the outer layer, crosslinking the matrix in the resin composition constituting the outer layer by bringing the outer layer into contact with water or water vapor.
